(19) United States
(12) Patent Application Publication
(10) Pub. No.: US 2021/0240313 A1
(43) Pub. Date: Aug. 5, 2021

(54) INPUT EDITING APPARATUS AND INPUT EDITING METHOD

(71) Applicant: SHARP KABUSHIKI KAISHA, Osaka (JP)

(72) Inventor: TAKASHI USUI, Osaka (JP)

(21) Appl. No.: 17/164,161

(22) Filed: Feb. 1, 2021

(30) Foreign Application Priority Data
Feb. 5, 2020 (JP) 2020-018192

(51) Int. Cl. G06F 3/0482; G06F 3/0485; G06F 3/0488

(52) U.S. Cl. CPC G06F 3/0482; G06F 3/04883; G06F 3/04855

(57) ABSTRACT

Provided is an input editing apparatus including a display that displays a drawn and input object, an object display that displays the object on the display, a cluster recognizer that recognizes trajectories of the object for each cluster, a section setter that sets a section in which recognized clusters are divided, a section display that displays the set section on the display, and a controller that controls to display the object in a first display region of the display and the section in a second display region of the display. The controller associates the object with the section and displays the section, based on a predetermined rule, and if an operation is performed on the selected section, the operation is reflected on the object associated with the selected section at a position where the object is displayed.

### BACKGROUND OF THE INVENTION

### Field of the Invention

The present invention relates to an input editing apparatus, and more particularly relates to an input editing apparatus or the like capable of displaying an object rendered and input on a display and easily editing the object.

### Description of the Background Art

Conventionally, there is known an information processing apparatus designed to select a part of a trajectory input by handwriting and perform an editing process on the selected part. In an example of a conventional technology, there is disclosed an information processing apparatus for accurately erasing a desired line in a handwriting input (see Japanese Unexamined Patent Application Publication No. 2016-24517, hereinafter, “Patent Document 1”).

Further, in other examples of a conventional technology, there are disclosed information processing apparatuses including: an apparatus for selecting various object selection patterns with only a unicursal trajectory input by handwriting (see Japanese Unexamined Patent Application Publication No. 2010-267079 (hereinafter, “Patent Document 2”)); and a display apparatus in which a user can instruct the display apparatus to erase a line displayed on the display by an intuitive and simple operation (see Japanese Unexamined Patent Application Publication No. 2013-12134 (hereinafter, “Patent Document 3”)).

However, in the above-mentioned conventional technologies, in an editing process, if the trajectory itself is selected (technology in Patent Document 1), the trajectory is surrounded (technology in Patent Document 2), and the trajectory is designated by contacting the trajectory (technology in Patent Document 3), a contact operation is performed on the object.

Therefore, when a part of a written trajectory is erased or edited on a large screen such as an electronic blackboard, if the trajectory is out of a user's reach, the user needs to move his or her body to perform the operation.

In addition, if it is difficult to directly select individual trajectories on a small screen such as a smartphone, zoom out/zoom in need to be repeated in each editing, and so there is a problem that it is not possible to smoothly perform delete/correction/editing operations.

Further, if drawn trajectories are a figure or a pattern, the trajectories often contact one another and cross in a complicated manner, and it is not easy to select a desired trajectory.

The present invention has been made in view of the above-mentioned conventional problems, and an object of the present invention is to provide an input editing apparatus or the like capable of easily selecting a trajectory of an object and performing an editing process.

### SUMMARY OF THE INVENTION

An input editing apparatus according to the present invention includes a display that displays an object drawn and input, an object display that displays the object on the display, a cluster recognizer that recognizes trajectories of the object for every cluster, the cluster including a plurality of the clusters, a section setter that sets a section in which the recognized clusters are divided, a section display that displays the set section on the display, and a controller that controls to display the object in a first display region of the display and to display the section in a second display region of the display. The controller associates the object with the section, displays the section, based on a predetermined rule, and if an operation is selectively performed on the selected section, reflects the operation on the object associated with the selected section at a position where the object is displayed.

Further, an input editing method according to the present invention includes displaying an object drawn and input, displaying the object on a display, recognizing trajectories of the object for every cluster, the cluster including a plurality of the clusters, setting a section in which the recognized clusters are divided, displaying the set section on the display, and controlling to display the object in a first display region of the display and to display the section in a second display region of the display. The object and the section are associated, the section is displayed based on a predetermined rule, and if an operation is selectively performed on the selected section, the operation is reflected on the object associated with the selected section at a position where the object is displayed.

According to an input editing apparatus and the like according to the present invention, a drawn and input object and a section in which trajectories of the object are divided into a cluster are displayed on the display, and when a selection operation, an editing operation, and the like are performed on the section, the operations are reflected on the object associated with the section. As a result, it is possible to realize an input editing apparatus and the like capable of easily performing an editing process without performing a direct operation on the object.

### BRIEF DESCRIPTION OF THE DRAWINGS

FIG. 1 is a block diagram illustrating a configuration of an input editing apparatus according to a first embodiment;

FIG. 2 is an explanatory diagram illustrating an example of a display screen of a display configuring the input editing apparatus;

FIG. 3 is an explanatory diagram illustrating an example of a display state of an object displayed on the display and a section associated with the object;

FIG. 4 is an explanatory diagram illustrating an example in which a part of an object displayed on a display of an input editing apparatus according to a second embodiment is displayed in highlight;

FIG. 5A to FIG. 5F are explanatory diagrams each illustrating another example in which a part of an object is displayed in highlight;

FIG. 6 is an explanatory diagram illustrating an example in which a part of an object displayed on a display of an input editing apparatus according to a third embodiment is displayed in highlight and semi-highlight;

FIG. 7 is an explanatory diagram illustrating an example in which a display region of a display screen of a display of an input editing apparatus according to a fourth embodiment is displayed in non-highlight except for a part of the display region;

FIG. 8 is an explanatory diagram illustrating an example in which a part of an object displayed on a display screen of a display of an input editing apparatus according to a fifth embodiment is pop-up displayed;

FIG. 9 is an explanatory diagram illustrating an example of a pop-up display of an edit menu displayed on a display screen of a display of an input editing apparatus according to a sixth embodiment;

FIG. 10A to FIG. 10I are explanatory diagrams each illustrating an example of a selectable item in the edit menu;

FIG. 11 is an explanatory diagram illustrating a relationship between a drawn and input object, a cluster configuring the object, and a section of the cluster, in an input editing apparatus according to a seventh embodiment;

FIG. 12 is an explanatory diagram illustrating a relationship between a drawn and input object, a cluster configuring the object, and a section of the cluster, in an input editing apparatus according to an eighth embodiment;

FIG. 13 is an explanatory diagram illustrating a relationship between a drawn and input object, a cluster configuring the object, and a section of the cluster, in an input editing apparatus according to a ninth embodiment;

FIG. 14 is an explanatory diagram illustrating a relationship between a drawn and input object, a cluster configuring the object, and a section of the cluster, in an input editing apparatus according to a tenth embodiment;

FIG. 15 is an explanatory diagram illustrating an example in which a section associated with an object categorized in an input order is displayed;

FIG. 16 is an explanatory diagram illustrating an example in which a section associated with an object categorized depending on each input time is displayed;

FIG. 17 is an explanatory diagram illustrating an example in which a section associated with an object categorized depending on each input person of an object is displayed;

FIG. 18 is an explanatory diagram illustrating a relationship between a drawn and input object, a cluster configuring the object, and a section of the cluster, in an input editing apparatus according to an eleventh embodiment;

FIG. 19 is an explanatory diagram illustrating a relationship between a drawn and input object, a cluster configuring the object, and a section of the cluster, in an input editing apparatus according to a twelfth embodiment;

FIG. 20 is an explanatory diagram illustrating a relationship between a drawn and input object, a cluster configuring the object, and a section of the cluster, in an input editing apparatus according to a thirteenth embodiment;

FIG. 21 is an explanatory diagram illustrating a positional relationship of adjacent sections associated with a drawn and input object and an interval between the sections, in an input editing apparatus according to a fourteenth embodiment; and

FIG. 22 is an explanatory diagram illustrating a modification of a positional relationship of adjacent sections associated with the object in the input editing apparatus.

### DESCRIPTION OF THE PREFERRED EMBODIMENTS

### First Embodiment

A first embodiment of the present invention will be described below with reference to the drawings.

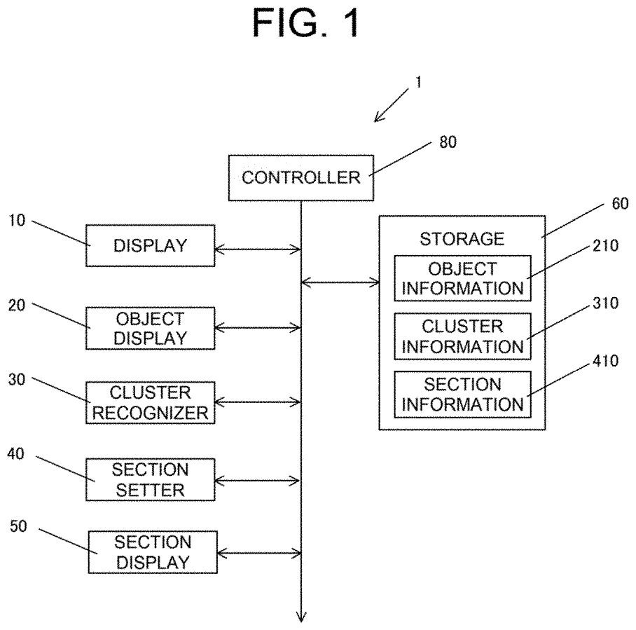

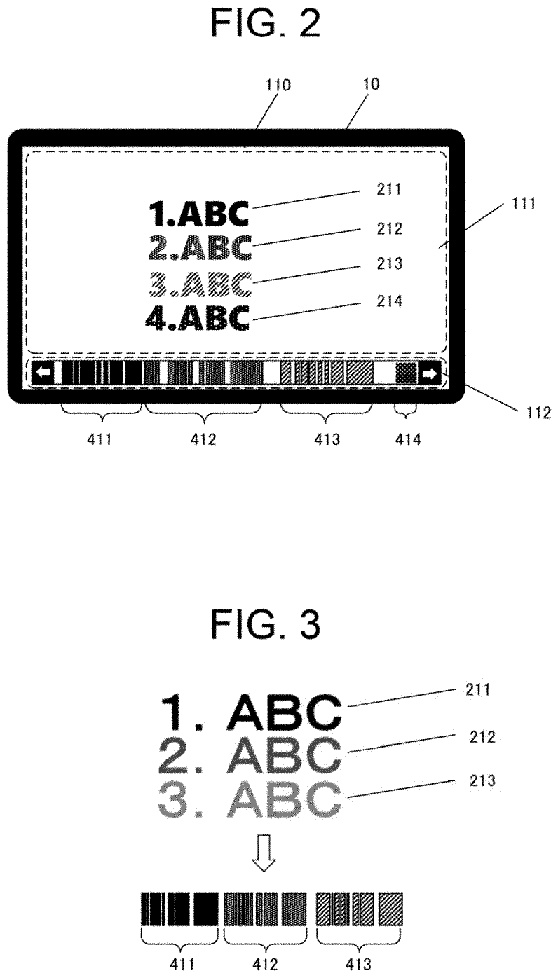

FIG. 1 is a block diagram illustrating an example of an embodiment in which the present invention is implemented, a configuration of an input editing apparatus according to a first embodiment of the present invention, FIG. 2 is an explanatory diagram illustrating an example of a display screen of a display configuring the input editing apparatus, and FIG. 3 is an explanatory diagram illustrating an example of a display state of an object displayed on the display and a section associated with the object.

The first embodiment is an input editing apparatus for selecting and editing an object displayed on a display, which is characterized by recognizing a trajectory of a drawn and input object for each cluster, setting a section in which recognized clusters are divided, displaying the object and the section in an associated manner on the display, and when the section is selected, and edited, for example, reflecting a process such as a selecting process and an editing process on the object associated with the section.

### Configuration of Input Editing Apparatus

First, a configuration of an input editing apparatus 1 according to the first embodiment will be described.

As illustrated in FIG. 1, the input editing apparatus 1 mainly includes a display 10, an object display 20, a cluster recognizer 30, a section setter 40, a section display 50, a storage 60, and a controller 80.

The display 10 displays a drawn and input object and a section associated with the object.

The object display 20 displays the object on the display 10.

The cluster recognizer 30 recognizes trajectories of the object for each cluster.

The section setter 40 sets a section in which recognized clusters are divided.

The section display 50 displays the set section on the display 10.

The cluster is a mode for dividing the trajectories of the object, and for example, includes (1) a cluster including a stroke configuring a trajectory, (2) a cluster including a group of continuously input strokes in terms of configuration (that in which the strokes are in contact), (3) a cluster including a group of strokes input continuously in time (for example, a collection of words and sentences), (4) a cluster including a group of trajectories obtained when the trajectories are separated in a vertical direction or in a horizontal direction (for example, a collection generated in each line break and in each item of sentences). Information about the cluster is stored in the storage 60 as cluster information.

The section is a representation of a rectangular shape obtained by dividing the above-mentioned cluster. Information about the section is stored in the storage 60 as section information.

In the first embodiment, as illustrated in FIG. 2, on a display screen 110 of the display 10, a first display region 111 in which the object is displayed and a second display region 112 in which the section associated with the object is displayed, are provided.

The second display region 112 is provided at a lower part of the display screen 110 across the entire end-to-end width direction. A region other than the second display region 112 of the display screen 110 is designated as the first display region 111.

Depending on a positional relationship between the display screen 110 and a user, the second display region 112 may be provided at an upper part of the display screen 110 and may be provided in a vertical display along an up-down direction at both left- and right ends of the display screen 110.

In the first embodiment, the first display region 111 and the second display region 112 are displayed at the upper part of the display screen 110, but a display style of the first display region 111 and the second display region 112 is not limited thereto, and both the regions 111 and 112 may not necessarily be displayed on the same screen.

In the storage 60, object information 210 about the drawn and input object, cluster information 310 about a cluster configuring the object, and section information 410 about a section in which the cluster is divided, are stored.

The controller 80 controls so that the drawn and input object is displayed as a main image in the first display region 111 and the section associated with the object is displayed in the second display region 112. The controller 80 associates the object with the section, displays the section, based on a predetermined rule, and when a selection operation, an editing operation, and the like are performed on the section, reflects the executed operation on the object associated with the section.

In the first embodiment, as illustrated in FIG. 2, in the first display region 111 of the display screen 110 of the display 10, first to fourth objects 211, 212, 213, and 214 rendered and input by handwriting are displayed. In the second display region 112, first to fourth sections 411, 412, 413, and 414 respectively associated with the first to fourth objects 211, 212, 213, and 214 are displayed. Each of the sections is displayed in a state where a plurality of sections in a rectangular shape are arranged side by side according to the cluster information.

In the first to fourth objects 211, 212, 213, and 214, the input trajectories (strokes) are displayed cumulatively displayed in chronological order.

The first to fourth sections 411, 412, 413, and 414 are cumulatively displayed in chronological order from a left direction to a right direction in FIG. 2, and are subject to a process according to a format of the first to fourth objects 211, 212, 213, and 214. Examples of the process according to a format include a color coding and a pattern display.

### Editing Object by Input Editing Apparatus

Next, selection and editing of an object drawn on and input to the display 10 of the input editing apparatus 1 will be described. When the object displayed on the display 10 is selected and edited, selection and editing are performed on the section associated with the object.

Firstly, the drawn and input object and the section associated with the object will be described.

As illustrated in FIG. 2, in the first to fourth objects 211, 212, 213, and 214 drawn on and input to the first display region 111 of the display 10, the trajectories (strokes) of the objects each drawn are divided into each cluster and recognized by the cluster recognizer 30.

The clusters recognized by the cluster recognizer 30 are divided by the section setter 40 and set as the first to fourth sections 411, 412, 413, and 414 including a plurality of sections in a rectangular shape respectively corresponding to the first to fourth objects 211, 212, 213, and 214.

The first to fourth sections 411, 412, 413, and 414 set by the section setter 40 are displayed in the second display region 112 of the display 10 by the section display 50.

Specifically, as illustrated in FIG. 3, if the first object 211 is displayed in black, the first section 411 is displayed in black. If the second object 212 is displayed in color, the second section 412 is displayed in color. If the third object 213 is displayed by hatching, the third section 413 is displayed by hatching.

If the first to third objects 211, 212, and 213 are edited, when the first to third sections 411, 412, and 413 are respectively selected and edited, the editing process is performed on the object corresponding to the section on which the editing operation is performed.

With such a configuration, according to the first embodiment, the input editing apparatus 1 includes the display 10, the object display 20, the cluster recognizer 30, the section setter 40, the section display 50, and the controller 80, where the section associated with the object is set, the object and the section are both displayed on the display 10, and the editing operation and the like are performed on the section displayed on the display 10. As a result, it is possible to edit the format and the like of the object without directly performing a selection operation, an editing operation, and the like on the object. As a consequence, on a large screen such as an electronic blackboard, it is possible to easily perform an editing operation on an object located far from a user, for example, an object located out of the reach of the user. Even if it is difficult to directly select a trajectory of an object on a small screen such as a smartphone, an editing operation is performed on a section associated with the object to perform the editing operation on a target object.

### Second Embodiment

Next, with reference to the drawings, a second embodiment will be described.

The second embodiment is characterized in that in the input editing apparatus 1, if a section is selected and operated by a user, an object associated with the selected section is displayed in highlight in a function of the controller 80.

It is noted that for convenience of explanation, components having the same functions as those in the first embodiment are designated by the same reference numerals, and description for those components will be omitted.

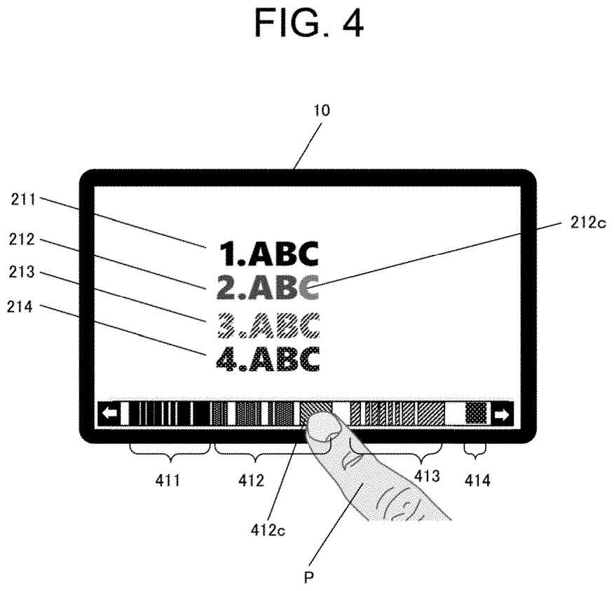

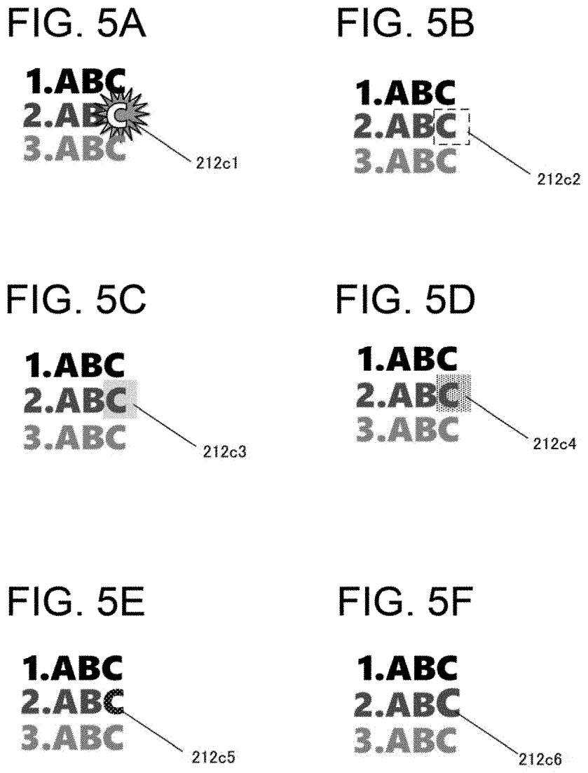

FIG. 4 is an explanatory diagram illustrating an example in which a part of an object displayed on the display of the input editing apparatus according to the second embodiment is displayed in highlight, and FIG. 5A to FIG. 5F are explanatory diagrams each illustrating another example in which a part of an object is displayed in highlight.

In the second embodiment, as illustrated in FIG. 4, in the second object 212 and the second section 412 displayed on the display screen 110 of the display 10 of the input editing apparatus 1, if a partial section 412c of the second section 412 is selected by a user P, the partial section 412c of the second section 412 and a partial object 212c of the second object 212 associated therewith are displayed in highlight.

In this case, if the partial section 412c of the second section 412 is selected by the user P, a format (color setting) of the partial section 412c of the second section 412 is changed to an emphasized color different from a color of the second section 412, and a color of the partial object 212c of the second object 212 associated with the partial section 412c of the second section 412 is changed to an emphasized color different from colors of the other sections, similarly to the partial section 412c of the second section 412.

As a result, the partial object 212c of the second object 212 is changed in display color to the emphasized color different from the color of the second object 212, and thus, the partial section 412c of the second section 412 and the partial object 212c of the second object 212 are displayed in highlight.

Other examples of the display in highlight are provided below.

A partial object 212c1 of the second object 212 illustrated in FIG. 5A is displayed in highlight by blinking.

A partial object 212c2 of the second object 212 illustrated in FIG. 5B is displayed in highlight by being surrounded with a broken line.

A partial object 212c3 of the second object 212 illustrated in FIG. 5C is displayed in highlight by being highlighted with a color marking or the like.

A partial object 212c4 of the second object 212 illustrated in FIG. 5D is displayed in highlight by being marked with a halftone dot.

A partial object 212c5 of the second object 212 illustrated in FIG. 5E is displayed in highlight by being displayed in a character with a halftone dot.

A partial object 212c6 of the second object 212 illustrated in FIG. 5F is displayed in highlight by being displayed in a bold character.

The display in highlight is not limited to the above-mentioned examples.

With such a configuration, according to the second embodiment, in the input editing apparatus 1, if the section is selected by the user P, the object associated with the selected section is displayed in highlight in a function of the controller 80, and as a result, it is possible to emphasize the object to be edited.

In the second embodiment, if the section is selected by the user P, the partial section 412c of the second section 412, and the partial object 212c of the second object 212 associated with the partial section 412c of the second section 412 are changed in emphasized color, and as a result, a positional relationship between the section and the object associated therewith is obvious, and therefore, it is possible for the user to easily recognize the object to be edited.

### Third Embodiment

Next, a third embodiment will be described with reference to the drawings.

The third embodiment is characterized in that in the input editing apparatus 1, if the section is selected and operated by a user, the object associated with a section adjacent to the selected section is displayed in highlight in an almost similar manner to the object associated with the selected section in a function of the controller 80.

It is noted that for convenience of explanation, components having the same functions as those in the first embodiment are designated by the same reference numerals, and description for those components will be omitted.

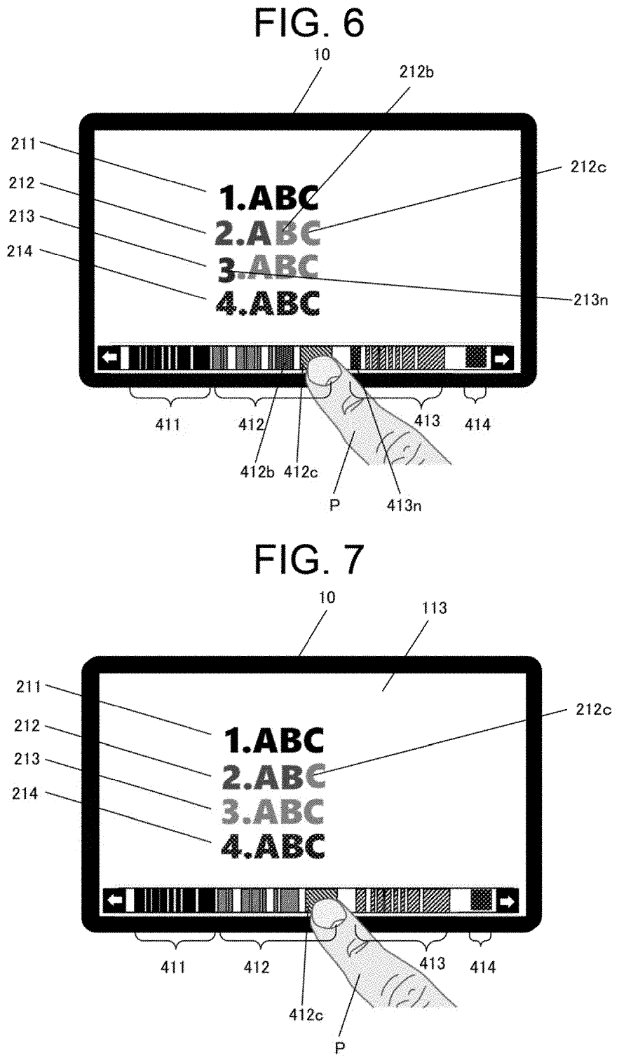

FIG. 6 is an explanatory diagram illustrating an example in which a part of the object displayed on a display of the input editing apparatus according to the third embodiment is displayed in highlight and semi-highlight.

In the third embodiment, as illustrated in FIG. 6, in the first to fourth objects 211, 212, 213, and 214 and the first to fourth sections 411, 412, 413, and 414 displayed on the display screen 110 of the display 10 of the input editing apparatus 1, if the partial section 412c of the second section 412 is selected by the user P, the partial object 212c of the second object 212 associated with the partial section 412c of the second section 412 is displayed in highlight, and in addition, a partial section 212b of the second object 212 and a partial section 213n of the third object 213 respectively associated with a partial section 412b of the second section 412 and a partial section 413n of the third section 413, which are adjacent to the partial section 412c of the second section 412, are displayed in semi-highlight.

In this case, if the partial section 412c of the second section 412 is selected by the user P, the partial section 412c of the second section 412 is displayed in highlight, and in addition, the partial section 412b of the second section 412 and the partial section 413n of the third section 413, which are adjacent to the partial section 412c of the second section 412, are displayed in semi-highlight in an almost similar manner to the partial section 412c of the second section 412.

With such a configuration, according to the third embodiment, in the input editing apparatus 1, if the section is selected by the user P, the object associated with the section adjacent to the selected section is displayed in semi-highlight in an almost similar manner to the object associated with the selected section in a function of the controller 80, and as a result, it is possible to emphasize a surrounding region including the object to be edited.

In the third embodiment, if the section is selected by the user P, the partial section 412c of the second section 412 is displayed in highlight, and in addition, the partial section 412b of the second section 412 and the partial section 413n of the third section 413, which are adjacent to the partial section 412c of the second section 412 are displayed in highlight in an almost similar manner to the partial section 412c of the second section 412, and as a result, a positional relationship between the section and the object associated therewith is more obvious, and therefore, it is easier for the user to recognize the object to be edited.

### Fourth Embodiment

Next, a fourth embodiment will be described with reference to the drawings.

The fourth embodiment is characterized in that, in the input editing apparatus 1, if the section is selected by the user P, a display region obtained by eliminating the object associated with the selected section, out of the display region of the display screen 110 of the display 10, is displayed in non-highlight in a function of the controller 80.

It is noted that for convenience of explanation, components having the same functions as those in the first embodiment are designated by the same reference numerals, and description for those components will be omitted.

FIG. 7 is an explanatory diagram illustrating an example in which a display region of a display screen of a display of the input editing apparatus according to the fourth embodiment is displayed in non-highlight except for a part of the display region.

In the fourth embodiment, as illustrated in FIG. 7, in the display screen 110 of the display 10 of the input editing apparatus 1, out of the first to fourth sections 411, 412, 413, and 414 associated with the first to fourth objects 211, 212, 213, and 214, if the partial section 412c of the second section 412 is selected by the user P, a display region 113 obtained by eliminating the partial object 212c of the second object 212 associated with the partial section 412c of the second section 412 is displayed in a so-called grayout state to be displayed in non-highlight.

In this case, the partial section 412c of the second section 412, selected by the user P, and the partial object 212c of the second object 212 are displayed in a color displayed in highlight in the display region 113.

With such a configuration, according to the fourth embodiment, in the input editing apparatus 1, if the section is selected by the user P, a display region obtained by eliminating the objects associated with the selected section, out of the display region 113 of the display screen 110 of the display 10, is displayed in non-highlight in a function of the controller 80. As a result, the object associated with the selected section is conversely displayed in highlight, and therefore, it is possible to easily recognize the object to be edited.

### Fifth Embodiment

Next, a fifth embodiment will be described with reference to the drawings.

The fifth embodiment is characterized in that in the input editing apparatus 1, if the section is selected by the user P, a neighboring display region including the object associated with the selected section is duplicated and an image in the duplicated display region is pop-up displayed adjacently to the selected section in a function of the controller 80.

It is noted that for convenience of explanation, components having the same functions as those in the first embodiment are designated by the same reference numerals, and description for those components will be omitted.

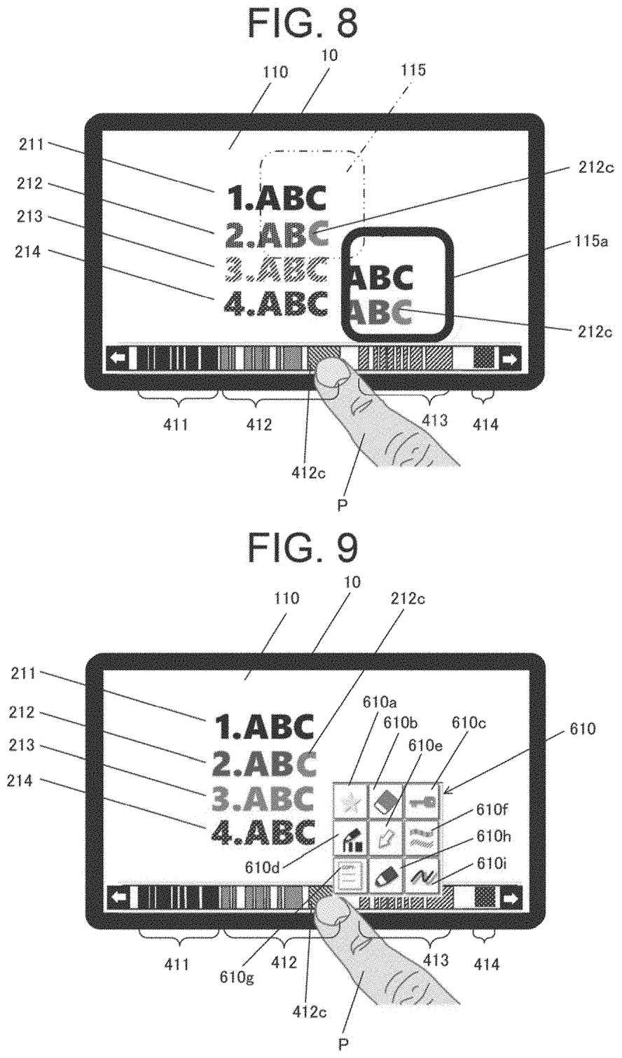

FIG. 8 is an explanatory diagram illustrating an example in which a part of an object displayed on the display screen of the display of the input editing apparatus according to the fifth embodiment is pop-up displayed.

In the fifth embodiment, as illustrated in FIG. 8, in the display screen 110 of the display 10 of the input editing apparatus 1, out of the first to fourth sections 411, 412, 413, and 414 associated with the first to fourth objects 211, 212, 213, and 214, if the partial section 412c of the second section 412 is selected by the user P, a display region 115 including the partial object 212c of the second object 212 associated with the partial section 412c of the second section 412 is duplicated and an image 115a in the duplicated display region 115 is pop-up displayed adjacently to the partial section 412c of the second section 412.

The partial section 412c of the second section 412, selected by the user P, is displayed in highlight.

The partial object 212c of the second object 212 associated with the partial section 412c of the second section 412 is displayed in highlight, similarly to the partial section 412c of the second section 412.

With such a configuration, according to the fifth embodiment, in the input editing apparatus 1, if the partial section 412c of the second section 412 is selected by the user P, when the display region 115 including the partial object 212c of the second object 212 associated with a partial section 412a of the second section 412 is duplicated and the image 115a in the duplicated display region 115 is pop-up displayed adjacently to the partial section 412c of the second section 412 in a function of the controller 80, it is possible to display a surrounding region including the object to be edited in a display region operable by the user P. As a result, it is possible to resolve a problem of impairing a continuity of operations due to a movement of a line of sight in a large display.

The image 115a in which the duplicated display region 115 is pop-up displayed may be displayed in an enlarged manner. For example, in an operation on a small screen such as a mobile terminal, when the image is display in an enlarged manner, it is possible to more precisely select and edit an object.

In the present embodiment, the object to be edited is displayed in highlight, but such an object may not necessarily be displayed in highlight. A frame indicating a range of the display region 115 including the object to be edited (for example, a frame of a two-dot chain line in FIG. 8) may be displayed on the display screen 110.

### Sixth Embodiment

Next, a sixth embodiment will be described with reference to the drawings.

The sixth embodiment is characterized in that in the input editing apparatus 1, if the section is selected by the user, an edit menu is pop-up displayed adjacently to the selected section in a function of the controller 80.

It is noted that for convenience of explanation, components having the same functions as those in the first embodiment are designated by the same reference numerals, and description for those components will be omitted.

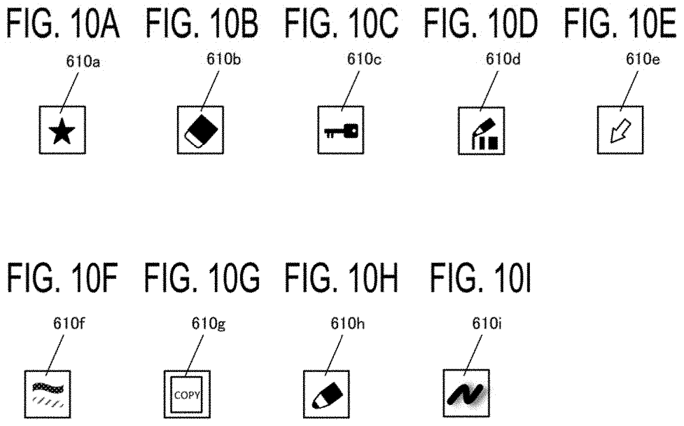

FIG. 9 is an explanatory diagram illustrating an example of a pop-up display of an edit menu displayed on the display screen of the display of an input editing apparatus according to the sixth embodiment, and FIG. 10A to FIG. 10I are explanatory diagrams each illustrating an example of a selectable item in the edit menu.

In the sixth embodiment, as illustrated in FIG. 9, in the display screen 110 of the display 10 of the input editing apparatus 1, if the partial section 412c of the second section 412 is selected by the user P, out of the first to fourth sections 411, 412, 413, and 414 associated with the first to fourth objects 211, 212, 213, and 214, an edit menu 610 in which an editable item is displayed is pop-up displayed.

As illustrated in FIG. 9, the edit menu 610 is provided with icons 610a to 610i in a selectable manner.

As illustrated in FIG. 10A, the icon 610a is an icon in which an image of a star is displayed, and is used to register a favorite.

As illustrated in FIG. 10B, the icon 610b is an icon in which an image of an eraser is displayed, and is used to erase a drawn image.

As illustrated in FIG. 10C, the icon 610c is an icon in which an image of a key is displayed, and is used to lock an input operation.

As illustrated in FIG. 10D, the icon 610d is an icon in which images of a pencil and a line are displayed, and is used to set a thickness of a drawn and input line.

As illustrated in FIG. 10E, the icon 610e is an icon in which an image of an arrow is displayed, and is used to designate and select a part.

As illustrated in FIG. 10F, the icon 610f is an icon in which an image of a drawing pattern is displayed, and is used to set a filling (fill) pattern of a drawn image.

As illustrated in FIG. 10G, the icon 610g is an icon in which an image indicating a copy process is displayed, and is used to execute a copying.

As illustrated in FIG. 10H, the icon 610h is an icon in which an image of a colored pencil is displayed, and is used to change a color of a drawing line.

As illustrated in FIG. 10I, the icon 610i is an icon in which images of a line drawing and a shadow thereof are displayed, and is used to perform a shading process on a drawing line.

With such a configuration, in the input editing apparatus 1, if the section is selected by the user, when the edit menu 610 is pop-up displayed adjacently to the selected section in a function of the controller 80, the icon displayed in the edit menu 610 is appropriately selected to easily perform a desired setting process.

In the sixth embodiment, in the input editing apparatus 1, the edit menu 610 is displayed on the display 10 and is displayed adjacently to the selected section, but the edit menu 610 may be displayed adjacently to the object associated with the selected section, for example.

When an operation (a click operation and a tap operation) is further performed on the object associated with the selected section, the edit menu 610 may be displayed adjacently to the object.

### Seventh Embodiment

Next, a seventh embodiment will be described with reference to the drawings.

The seventh embodiment is characterized in that in the input editing apparatus 1, a cluster for dividing trajectories of an object includes one stroke (the number of strokes) of the input trajectory of the object.

FIG. 11 is an explanatory diagram illustrating a relationship between a drawn and input object, a cluster configuring the object, and a section of the cluster, in the input editing apparatus according to the seventh embodiment.

In the seventh embodiment, as illustrated in FIG. 11, an object G1 drawn on and input to the display screen 110 of the display 10 of the input editing apparatus 1 is an alphabet “H”, for example.

Trajectories for drawing and inputting the object G1 are configured by three strokes (the number of strokes is 3).

The object G1 is recognized by the cluster recognizer 30 as a cluster C1 including one vertical stroke, a cluster C2 including one vertical stroke, and a cluster C3 including one horizontal stroke, separately.

The recognized clusters C1, C2, and C3 are set, by the section setter 40, with sections S1, S2, and S3 for each cluster.

The sections S1, S2, and S3 are each formed in a rectangular shape. A horizontal width (w) of each rectangle of the sections S1, S2, and S3 is set according to a length of one stroke of each cluster.

That is, the horizontal width (w) of the section S1 is set to w1 having a length as long as the one vertical stroke.

The horizontal width (w) of the section S2 is set to w2 having a length as long as one vertical stroke.

The horizontal width (w) of the section S3 is set to w3 having a length as long as one horizontal stroke,

With such a configuration, according to the seventh embodiment, in the input editing apparatus 1, the cluster for dividing the trajectories of the object G1 is recognized as the clusters C1, C2, and C3 configured by one stroke (the number of strokes) of the input trajectories of the object, the clusters C1, C2, and C3 are set as the sections S1, S2, and S3, and as a result, it is possible to operate the object G1 separately for each section to finely adjust, correct, and change the object G1.

### Eighth Embodiment

Next, an eighth embodiment will be described with reference to the drawings.

The eighth embodiment is characterized in that in the input editing apparatus 1, a cluster for dividing trajectories of an object is strokes obtained when the continuously input trajectories contact each other, out of the input trajectories of the object.

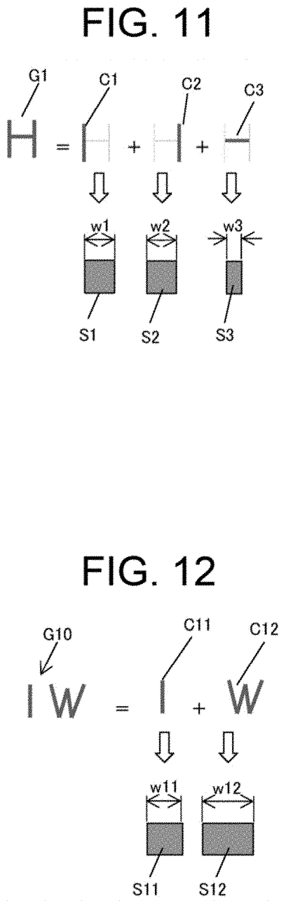

FIG. 12 is an explanatory diagram illustrating a relationship between a drawn and input object, a cluster configuring the object, and a section of the cluster, in the input editing apparatus according to the eighth embodiment.

In the eighth embodiment, as illustrated in FIG. 12, an object G10 drawn on and input to the display screen 110 of the display 10 of the input editing apparatus 1 is alphabetical letters “IW”, for example.

The trajectories for drawing and inputting the object G10 are configured by two alphabetical letters of “I” and “W”.

The object G10 is recognized by the cluster recognizer 30 separately as a cluster C11 including “I” that is one alphabetical letter and a cluster C12 including “W” that is one alphabetical letter, which are formed of strokes obtained when continuously input trajectories contact each other.

The recognized clusters C11 and C12 are set, by the section setter 40, with the sections S11 and S12 for each cluster.

The sections S11 and S12 are each formed in a rectangular shape. A horizontal width (w) of each of rectangles of the sections S11 and S12 is set according to a length of strokes obtained when the continuously input trajectories of each cluster contact each other.

That is, the horizontal width (w) of the section S11 is set to w11 according to a length of strokes configuring a letter “I”.

The horizontal width (w) of the section S12 is set to w12 according to a length of strokes configuring a letter “W”.

With such a configuration, according to the eighth embodiment, in the input editing apparatus 1, in the cluster for dividing the trajectories of the object G10, the clusters configured by the strokes obtained when the continuously input trajectories, out of the input trajectories of the object, contact each other are recognized as the clusters C11 and C12, the clusters C11 and C12 are set as the sections S11 and S12, and as a result, it is possible to operate the object for each section obtained when the strokes continuously contact each other to adjust, correct, and change the object without impairing a balance of a shape for each section.

### Ninth Embodiment

Next, a ninth embodiment will be described with reference to the drawings.

The ninth embodiment is characterized in that in the input editing apparatus 1, a cluster for dividing trajectories of an object is a continuously input trajectory, out of input trajectories of the object.

A state in which the object is continuously input is a state in which the object is continuously input obtained without a non-input time exceeding a predetermined time.

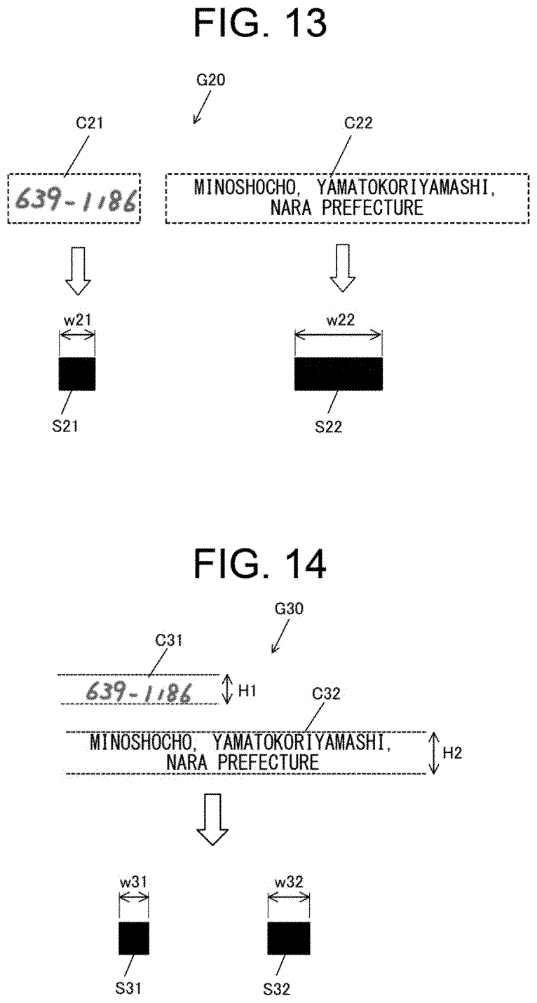

FIG. 13 is an explanatory diagram illustrating a relationship between a drawn and input object, a cluster configuring the object, and a section of the cluster, in the input editing apparatus according to the ninth embodiment.

In the ninth embodiment, as illustrated in FIG. 13, an object G20 drawn on and input to the display screen 110 of the display 10 of the input editing apparatus 1 is “639-1186, Minoshocho, Yamatokoriyamashi, Nara Prefecture”, for example.

The continuous trajectories for drawing and inputting the object G20 are configured by two aggregates, that is, a cluster C21 of “639-1186” and a cluster C22 of “Minoshocho, Yamatokoriyamashi, Nara Prefecture”, which are a word or a sentence.

The object G20 is recognized by the cluster recognizer 30 as an aggregate of letters continuously input within a predetermined time interval, that is, the cluster C21 including “639-1186” and the cluster C22 including “Minoshocho, Yamatokoriyamashi, Nara Prefecture”, separately.

The recognized clusters C21 and C22 are set, by the section setter 40, with sections S21 and S22 for each cluster.

The sections S21 and S22 are each formed in a rectangular shape. A horizontal width (w) of each of the rectangles of the sections S21 and S22 is set according to the number of letters consecutively input within a predetermined time interval of each of the clusters.

That is, the horizontal width (w) of the section S21 is set to w21 according to the number of letters of the cluster C21 of “639-1186”. The horizontal width (w) of the section S22 is set to w22 according to the number of letters of the cluster C22 of “Minoshocho, Yamatokoriyamashi, Nara Prefecture”.

With such a configuration, according to the ninth embodiment, in the input editing apparatus 1, in the cluster for dividing the trajectories of the object G20, an aggregate of letters continuously input within a predetermined time interval, out of input trajectories of the object, is recognized as the clusters C21 and C22, and the clusters C21 and C22 are set as the sections S21 and S22. As a result, it is possible to operate the object as an aggregate of continuous letters for each section to adjust, correct, and change the object for each word and sentence.

### Tenth Embodiment

Next, a tenth embodiment will be described with reference to the drawings.

The tenth embodiment is characterized in that in the input editing apparatus 1, a cluster for dividing trajectories of an object divides, out of the input trajectories of the object, the input trajectories at a time point when a display mode of the input trajectories of the object is changed when the trajectories are displayed in either a vertical direction or a horizontal direction.

FIG. 14 is an explanatory diagram illustrating a relationship between a drawn and input object, a cluster configuring the object, and a section of the cluster, in the input editing apparatus according to the tenth embodiment.

In the tenth embodiment, as illustrated in FIG. 14, an object G30 drawn on and input to the display screen 110 of the display 10 of the input editing apparatus 1 is “639-1186, Minoshocho, Yamatokoriyamashi, Nara Prefecture”, for example.

At a time point when the trajectories for drawing and inputting the object G30 are input in a horizontal direction to input “639-1186”, after a new line in an upward direction starts, the trajectories have an input as “Minoshocho, Yamatokoriyamashi, Nara Prefecture”.

The object G30 has a next line after “639-1186” is input and has “Minoshocho, Yamatokoriyamashi, Nara Prefecture” input in a next paragraph. As a result, the object G30 is recognized by the cluster recognizer 30 as a cluster C31 including “639-1186” and as a cluster C32 including “Minoshocho, Yamatokoriyamashi, Nara Prefecture”, separately.

The recognized clusters C31 and C32 are set, by the section setter 40, with sections S31 and S32 for each cluster.

Configuration is that a height of the object “639-1186” configuring the cluster C31 is H1, and a height of the object “Minoshocho, Yamatokoriyamashi, Nara Prefecture” configuring the cluster C32 is H2.

The sections S31 and S32 are each formed in a rectangular shape. A horizontal width (w) of each of the rectangles of the sections S31 and S32 is set according to a height of the objects configuring the cluster.

That is, the horizontal width (w) of the section S31 is set to w31 according to the height H1 of the object “639-1186” of the cluster C31. The horizontal width (w) of the section S32 is set to w32 according to the height H2 of the object “Minoshocho, Yamatokoriyamashi, Nara Prefecture” of the cluster C32.

With such a configuration, according to the tenth embodiment, in the input editing apparatus 1, when the input trajectories of the object are displayed in a horizontal direction, based on a predetermined rule, the cluster for dividing the trajectories of the object G30 is recognized as the cluster C31 and C32 obtained by dividing the trajectories by which the object G30 is input at a time point when the input trajectories of the object are changed in display mode as a result of a line break, and the clusters C31 and C32 are set as the sections S31 and S32, and as a result, it is possible to adjust, correct, and change the object collectively for each line break and item.

In the tenth embodiment, the rectangular horizontal widths (w) of the sections S31 and S32 are set respectively according to the heights H1 and H2 of the objects configuring the cluster, and thus, it is easy to recognize the size of the object associated with the sections S31 and S32, based on the rectangular horizontal widths (w) of the sections S31 and S32.

### Display of Section

Here, a manner in which a section corresponding to a drawn and input object is displayed in the input editing apparatus 1 will be described with reference to the drawings.

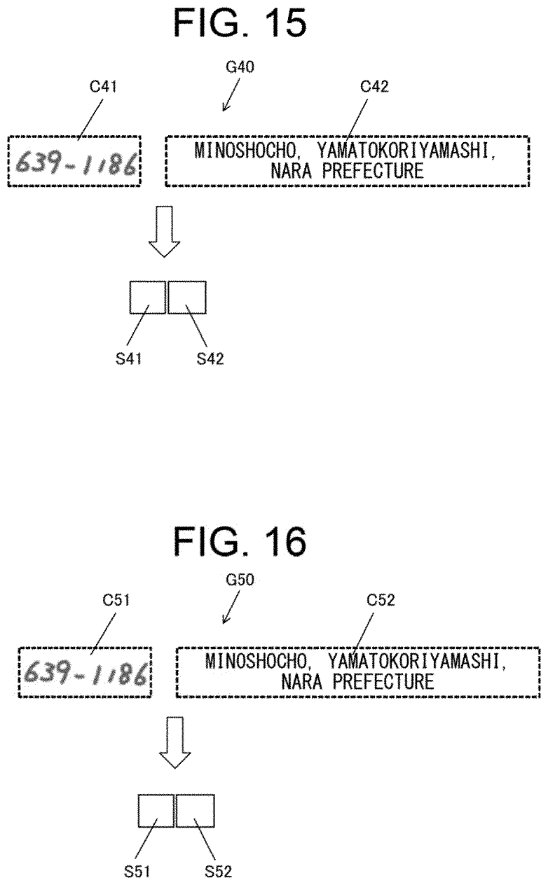

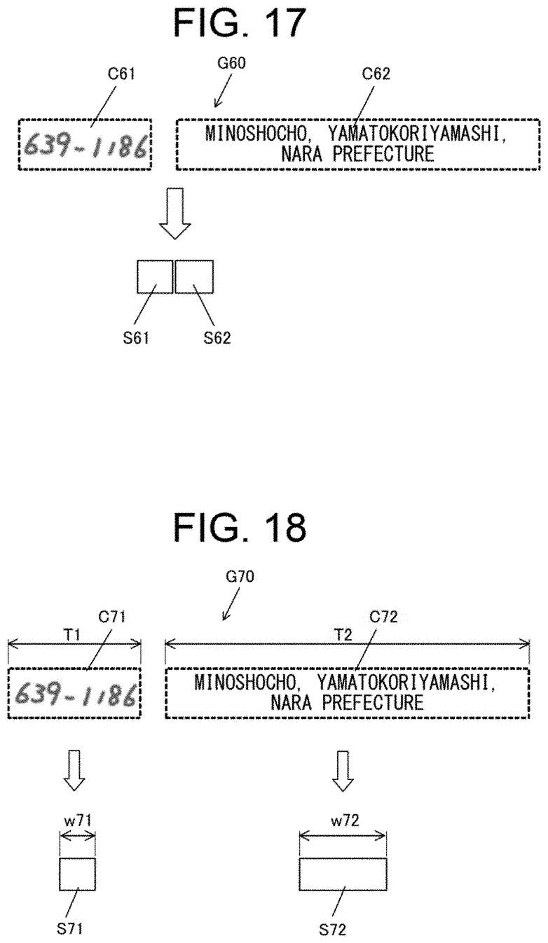

FIG. 15 is an explanatory diagram illustrating an example in which a section associated with an object categorized in an input order is displayed, FIG. 16 is an explanatory diagram illustrating an example in which a section associated with an object categorized depending on each input time is displayed, and FIG. 17 is an explanatory diagram illustrating an example in which a section associated with an object categorized depending on each input person of the object is displayed.

### Example 1

In Example 1, as illustrated in FIG. 15, clusters C41 and C42 are recognized, for a drawn and input object G40, by the cluster recognizer 30 in an order in which the object is input, sections S41 and S42 for dividing the clusters C41 and C42 are set by the section setter 40, and the sections S41 and S42 are displayed side by side by the section display 50.

With such a configuration, it is possible to set the sections S41 and S42 associated with the object G40 by a simple rule.

### Example 2

In Example 2, as illustrated in FIG. 16, clusters C51 and C52 are recognized, for a drawn and input object G50, by the cluster recognizer 30 according to a time when the object is input, sections S51 and S52 for dividing the clusters C51 and C52 are set by the section setter 40, and the sections S51 and S52 are displayed side by side by the section display 50.

With such a configuration, even if the object is drawn and input after a lapse of time, it is possible to intuitively recognize a difference in time when the object is drawn.

### Example 3

In Example 3, as illustrated in FIG. 17, clusters C61 and C62 are recognized, for a drawn and input object G60, by the cluster recognizer 30 according to an input person inputting the object, sections S61 and S62 for dividing the clusters C61 and C62 are set by the section setter 40, and the sections S61 and S62 are displayed side by side by the section display 50.

With such a configuration it is possible to, for example, restrict or permit a correction authority for each input person.

### Eleventh Embodiment

Next, an eleventh embodiment will be described with reference to the drawings.

The eleventh embodiment is characterized in that in the input editing apparatus 1, a horizontal width of a section associated with an object is set based on a time required to input trajectories of the object associated with the section.

FIG. 18 is an explanatory diagram illustrating a relationship between a drawn and input object, a cluster configuring the object, and a section of the cluster, in the input editing apparatus according to the eleventh embodiment.

In the eleventh embodiment, as illustrated in FIG. 18, an object G70 drawn on and input to the display screen 110 of the display 10 of the input editing apparatus 1 is “639-1186, Minoshocho, Yamatokoriyamashi, Nara Prefecture”, for example.

The trajectories for drawing and inputting the object G70 are recognized by the cluster recognizer 30 as a cluster C71 including the object “639-1186” and as a cluster C72 including the object “Minoshocho, Yamatokoriyamashi, Nara Prefecture”, separately.

When the object G70 is drawn and input, a time T1 is required to input the object “639-1186” configuring the cluster C71, and a time T2 is required to input the object “Minoshocho, Yamatokoriyamashi, Nara Prefecture” configuring the cluster C72.

The recognized clusters C71 and C72 are set, by the section setter 40, with sections S71 and S72 for each cluster.

The sections S71 and S72 are each formed in a rectangular shape. A horizontal width (w) of each of the rectangles of the sections S71 and S72 is set according to a length of the time required for inputting each object configuring the cluster.

That is, the horizontal width (w) of the section S71 is set to w71 according to the time T1 required to input the object “639-1186” of the cluster C71. The horizontal width (w) of the section S72 is set to w72 according to the time T2 required to input the object “Minoshocho, Yamatokoriyamashi, Nara Prefecture” of the cluster C72.

With such a configuration, according to the eleventh embodiment, in the input editing apparatus 1, the horizontal widths (w) of the sections S71 and S72 associated with the object G70 are set according to the times T1 and T2 required to input the object associated with each section, and therefore, it is possible to clearly confirm the association between an actual object trajectory and the section in a chronological display.

### Twelfth Embodiment

Next, a twelfth embodiment will be described with reference to the drawings.

The twelfth embodiment is characterized in that in the input editing apparatus 1, a horizontal width of a section associated with an object is set based on a length of trajectories of the object associated with the section.

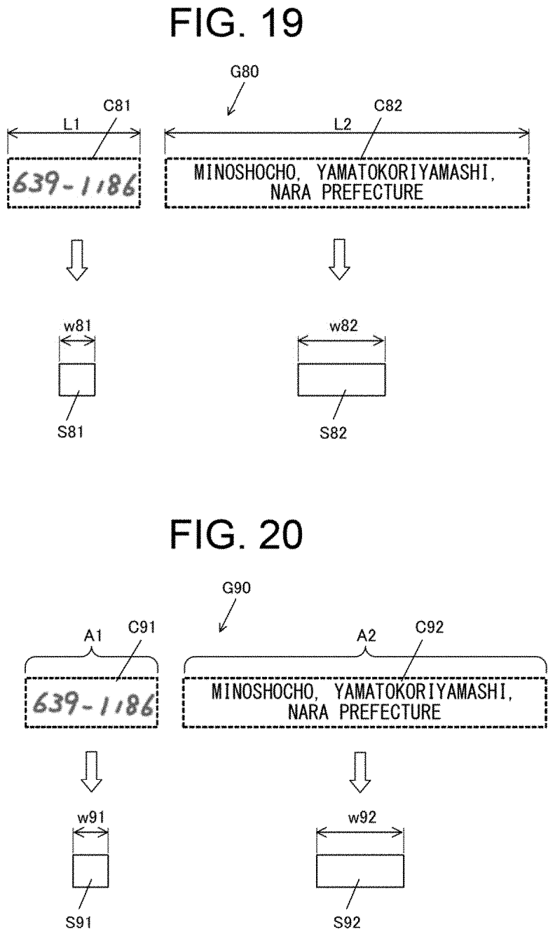

FIG. 19 is an explanatory diagram illustrating a relationship between a drawn and input object, a cluster configuring the object, and a section of the cluster, in the input editing apparatus according to the twelfth embodiment.

In the twelfth embodiment, as illustrated in FIG. 19, an object G80 drawn on and input to the display screen 110 of the display 10 of the input editing apparatus 1 is “639-1186, Minoshocho, Yamatokoriyamashi, Nara Prefecture”, for example.

The trajectories for drawing and inputting the object G80 are recognized by the cluster recognizer 30 as a cluster C81 including the object “639-1186” and as a cluster C82 including the object “Minoshocho, Yamatokoriyamashi, Nara Prefecture”, separately.

In the object G80, a length of trajectories of the object “639-1186” configuring the cluster C81 is a trajectory length L1, and a length of trajectories of the object “Minoshocho, Yamatokoriyamashi, Nara Prefecture” configuring the cluster C82 is a trajectory length L2.

The recognized clusters C81 and C82 are set, by the section setter 40, with sections S81 and S82 for each cluster.

The sections S81 and S82 are each formed in a rectangular shape. A horizontal width (w) of each of the rectangles of the sections S81 and S82 is set according to a trajectory length of each object configuring the cluster.

That is, the horizontal width (w) of the section S81 is set to w81 according to the trajectory length L1 of the object “639-1186” of the cluster C81. The horizontal width (w) of the section S82 is set to w82 according to the trajectory length L2 of the object “Minoshocho, Yamatokoriyamashi, Nara Prefecture” of the cluster C82.

With such a configuration, according to the twelfth embodiment, in the input editing apparatus 1, the horizontal widths (w) of the sections S81 and S82 associated with the object G80 are set according to the trajectory lengths L1 and L2 of the object associated with each section, and therefore, it is easily to imagine the object associated with the section.

### Thirteenth Embodiment

Next, a thirteenth embodiment will be described with reference to the drawings.

The thirteenth embodiment is characterized in that in the input editing apparatus 1, a horizontal width of a section associated with an object is set based on an area (thickness) of trajectories of the object associated with the section.

FIG. 20 is an explanatory diagram illustrating a relationship between a drawn and input object, a cluster configuring the object, and a section of the cluster, in the input editing apparatus according to the thirteenth embodiment.

In the thirteenth embodiment, as illustrated in FIG. 20, an object G90 drawn on and input to the display screen 110 of the display 10 of the input editing apparatus 1 is “639-1186, Minoshocho, Yamatokoriyamashi, Nara Prefecture”, for example.

The trajectories for drawing and inputting the object G90 are recognized by the cluster recognizer 30 as a cluster C91 including the object “639-1186” and as a cluster C92 including the object “Minoshocho, Yamatokoriyamashi, Nara Prefecture”, separately.

In the object G90, a thickness of a line of trajectories of the object “639-1186” configuring the cluster C91 is a line thickness A1, and a thickness of a line of trajectories of the object “Minoshocho, Yamatokoriyamashi, Nara Prefecture” configuring the cluster C92 is a line thickness A2.

The recognized clusters C91 and C92 are set, by the section setter 40, with sections S91 and S92 for each cluster.

The sections S91 and S92 are each formed in a rectangular shape. A horizontal width (w) of each of the rectangles of the sections S91 and S92 is set according to the thickness of the line of each object configuring the cluster.

That is, the horizontal width (w) of the section S91 is set to w91 according to the line thickness A1 of the object “639-1186” of the cluster C91. The horizontal width (w) of the section S92 is set to w92 according to the line thickness A2 of the object “Minoshocho, Yamatokoriyamashi, Nara Prefecture” of the cluster C92.

With such a configuration, according to the thirteenth embodiment, in the input editing apparatus 1, when the horizontal widths (w) of the sections S91 and S92 associated with the object G90 are set according to the line thicknesses A1 and A2 of the object associated with each section, and therefore, it is easy to recognize the section and the object associated with the section.

In a modification of the thirteenth embodiment, the horizontal width (w) of the section associated with the object may have a value obtained by adding a specific coefficient as a fixed value to a value of the line thickness set based on the trajectories of the object associated with the section.

### Fourteenth Embodiment

Next, a fourteenth embodiment will be described with reference to the drawings.

The fourteenth embodiment is characterized in that in the input editing apparatus 1, sections associated with adjacent objects are displayed at intervals, and such an interval is set according to a non-input time until before trajectories of an object associated with a subsequent section are input after trajectories of an object associated with one section are input.

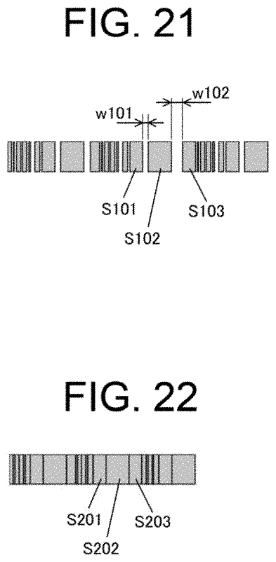

FIG. 21 is an explanatory diagram illustrating a positional relationship of adjacent sections associated with a drawn and input object and an interval between the sections, in an input editing apparatus according to the fourteenth embodiment, and FIG. 22 is an explanatory diagram illustrating a modification of a positional relationship between adjacent sections associated with an object in the input editing apparatus according to the fourteenth embodiment.

In the fourteenth embodiment, as illustrated in FIG. 21, in adjacent sections S101, S102, and S103, the section S101 and the section S102 are provided with an interval w101, and the section S102 and the section S103 are provided with an interval w102.

The interval w101 indicates a non-input time, as an interval, after the trajectories of the object associated with the section S101 are input until the trajectories of the object associated with the subsequent section S102 are input.

The interval w102 indicates a non-input time, as an interval, after the trajectories of the object associated with the section S102 are input until the trajectories of the object associated with the subsequent section S103 are input.

Here, the interval w102 has a wider width than the interval w101. This indicates that the non-input time corresponding to the interval w102 is longer than the non-input time corresponding to the interval w101.

With such a configuration, according to the fourteenth embodiment, in the input editing apparatus 1, the sections associated with the adjacent objects are indicated with an interval according to the non-input time after the trajectories of the object associated with one section are input until the trajectories of the object associated with the subsequent section are input, and therefore, it is possible to clearly display a temporal positional relationship between the sections. As a result, in a case where an account of meeting using a video and an audio is created, it is possible to easily establish a temporal consistency between a video recording and an audio recording.

In the modification of the fourteenth embodiment, as illustrated in FIG. 22, it may not be necessary to have an interval between the sections associated with the adjacent objects, for example, the sections S201, S202, and S203. In this case, for example, when the object is edited, it is easy to select the section.

As described above, the present invention is not limited to the above-described embodiments, and various modifications can be made without departing from the scope of the claims. It is obvious that those skilled in the art can conceive variations or modifications included in the scope of claims. In other words, the technical scope of the present invention includes embodiments implemented as combinations of technical means modified as appropriate without departing from the spirit of the present invention.

What is claimed is:

1. An input editing apparatus, comprising:
a display that displays an object drawn and input;
an object display that displays the object on the display;
a cluster recognizer that recognizes trajectories of the object for every cluster, the cluster including a plurality of the clusters;
a section setter that sets a section in which the recognized clusters are divided;
a section display that displays the set section on the display; and
a controller that controls to display the object in a first display region of the display and to display the section in a second display region of the display, wherein
the controller:
associates the object with the section;
displays the section, based on a predetermined rule; and
if an operation is performed on the selected section, reflects the operation on the object associated with the selected section at a position where the object is displayed.

2. The input editing apparatus according to claim 1, wherein the controller applies a format corresponding to the object to the operation performed on the section.

3. The input editing apparatus according to claim 1, wherein if the section is selected, the controller displays in highlight the object associated with the selected section.

4. The input editing apparatus according to claim 1, wherein if the section is selected, the controller pop-up displays an edit menu.

5. The input editing apparatus according to claim 1, wherein the cluster is one stroke of input trajectories of the object.

6. The input editing apparatus according to claim 1, wherein the cluster is formed of mutually contacting trajectories that are continuously input, out of input trajectories of the object.

7. The input editing apparatus according to claim 1, wherein the cluster is formed of continuously input trajectories, out of input trajectories of the object.

8. The input editing apparatus according to claim 1, wherein the cluster divides the input trajectories at a time point when a display mode of the input trajectories of the object is changed when the trajectories are projected in either a vertical direction or a horizontal direction, out of input trajectories of the object.

9. The input editing apparatus according to claim 1, wherein a horizontal width of the section is set based on a time required to input the trajectories of the object associated with the section.

10. The input editing apparatus according to claim 1, wherein a horizontal width of the section is set based on a length of the trajectories of the object associated with the section.

11. The input editing apparatus according to claim 1, wherein adjacent sections are displayed at an interval, and
the interval is set according to a non-input time after trajectories of an object associated with one section are input until before trajectories of an object associated with a subsequent section are input.

12. An input editing method, comprising:
displaying an object drawn and input;
displaying the object on a display;
recognizing trajectories of the object for every cluster, the cluster including a plurality of the clusters;
setting a section in which the recognized clusters are divided;
displaying the set section on the display; and
controlling to display the object in a first display region of the display and to display the section in a second display region of the display, wherein
the object and the section are associated, the section is displayed based on a predetermined rule, and if an operation is performed on the selected section, the operation is reflected on the object associated with the selected section at a position where the object is displayed.
